(19) United States
(12) Patent Application Publication
(10) Pub. No.: US 2022/0074731 A1
(43) Pub. Date: Mar. 10, 2022

(54) ROTOR APPARATUS WITH EFFECTIVE IDENTIFICATION OF ANGULAR POSITION AND ELECTRONIC DEVICE

(71) Applicant: Samsung Electro-Mechanics Co., Ltd., Suwon-si (KR)

(72) Inventors: Su Bong JANG, Suwon-si (KR); Hee Soo YOON, Suwon-si (KR); Sang Jong LEE, Suwon-si (KR); Seung Jae SONG, Suwon-si (KR); Seong Hwan LEE, Suwon-si (KR)

(73) Assignee: Samsung Electro-Mechanics Co., Ltd., Suwon-si (KR)

(21) Appl. No.: 17/101,070

(22) Filed: Nov. 23, 2020

(30) Foreign Application Priority Data
Sep. 7, 2020 (KR) 10-2020-0113647

(51) Int. Cl. G01B 7/30; G01D 5/20; G04G 21/00; G04B 3/04

(52) U.S. Cl. CPC G01B 7/30; G04B 3/041; G04G 21/00; G01D 5/20

(57) ABSTRACT

A rotor apparatus is provided. The rotor apparatus includes a rotor, configured to rotate around a rotational axis, an angular position identification layer configured to surround surface of the rotor, and configured to rotate with the rotor, and configured to have a width that varies based on an angular position of the rotor, and a permeability layer configured to surround the surface of the rotor, and configured to have a higher permeability than a permeability of the rotor.

### CROSS-REFERENCE TO RELATED APPLICATION(S)

This application claims the benefit under 35 USC 119(a) of Korean Patent Application No. 10-2020-0113647 filed on Sep. 7, 2020 in the Korean Intellectual Property Office, the entire disclosure of which is incorporated herein by reference for all purposes.

### BACKGROUND

### 1. Field

The following description relates to a rotor apparatus with effective identification of an angular position and an electronic device.

### 2. Description of Related Art

Recently, the features and form factor of electronic devices have diversified. Additionally, the diversification of user demands for electronic devices has increased, and requirements for functions and form factors of electronic devices have increased with the increase in diversification.

Accordingly, electronic devices may include a rotor to satisfy various user demands, based on efficient movement and design of the rotor.

The above information is presented as background information only to assist in an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a rotor apparatus includes a rotor, configured to rotate around a rotational axis; an angular position identification layer, configured to surround a surface of the rotor, and configured to rotate with the rotor, and configured to have a width that varies based on an angular position of the rotor; and a permeability layer, configured to surround the surface of the rotor, and configured to have a higher permeability than a permeability of the rotor.

The angular position identification layer may include a first angular position identification layer, disposed to surround the surface of the rotor, and configured to have a width that varies based on the angular position of the rotor; and a second angular position identification layer, spaced apart from the first angular position identification layer, disposed to surround the surface of the rotor, and configured to have a width that varies based on the angular position of the rotor.

The first angular position identification layer and the second angular position identification layer may be disposed such that a maximum width of the first angular position identification layer and a maximum width of the second angular position identification layer do not overlap each other in a rotation direction of the rotor.

The first angular position identification layer and the second angular position identification layer have substantially a same shape, and a first of the first angular position identification layer and the second angular position identification layer may rotate ¼ turn more than a second of the first angular position identification layer and the second angular position identification layer to be disposed to surround the surface of the rotor.

Each of the first angular position identification layer and the second angular position identification layer may be configured to have a sinusoidal wave-shaped boundary line.

The permeability layer includes a first permeability layer, disposed to surround the surface of the rotor, and configured to have a higher permeability than the permeability of the rotor, and configured to have a width that is larger than a maximum width of the first angular position identification layer; and a second permeability layer, spaced apart from the first permeability layer to surround the surface of the rotor, and configured to have a higher permeability than the permeability of the rotor and configured to have a width that is larger than a maximum width of the second angular position identification layer.

A width of the permeability layer may be less than a length of the rotor in a direction of the rotational axis.

The permeability layer may be disposed to overlap the angular position identification layer in a normal direction of the surface of the rotor.

The angular position identification layer may include at least one of copper, silver, gold, and aluminum.

The rotor may be composed of a plastic material.

The rotor apparatus may include a rotary head, coupled to a first end of the rotor and configured to have a diameter that is larger than a diameter of the rotor.

The rotor apparatus may include an inductor, configured to output magnetic flux toward the surface of the rotor; and a base member, configured to fix a positional relationship between the inductor and the rotor.

The rotor apparatus may include an angular position sensing circuit, configured to generate an angular position value based on an inductance of the inductor; and a substrate, disposed on the base member, wherein the angular position sensing circuit and the inductor are disposed on the substrate.

The base member may have a through-hole, and the rotor is configured to penetrate through the through-hole.

In a general aspect, a rotor apparatus includes a rotor, configured to rotate around a rotational axis; and an angular position identification layer, configured to surround an inner surface of the rotor, and configured to rotate with the rotor, and configured to have a width that varies based on an angular position of the rotor, wherein the rotor is configured to have a higher permeability than the angular position identification layer.

The angular position identification layer may include at least one of copper, silver, gold, and aluminum.

The rotor apparatus may include a rotary head, coupled to a first end of the rotor, and configured to have a diameter that is larger than a diameter of the rotor, wherein the rotary head is composed of a plastic material.

The rotor apparatus may include an inductor, configured to output magnetic flux toward the surface of the rotor; and a base member, configured to fix a positional relationship between the inductor and the rotor, and configured to have a through-hole, wherein the rotor is configured to penetrate through the through-hole.

The angular position identification layer may include a first angular position identification layer, disposed to surround the surface of the rotor, and configured to have a width that varies based on the angular position of the rotor; and a second angular position identification layer, spaced apart from the first angular position identification layer, disposed to surround the surface of the rotor, and configured to have a width that varies based on the angular position of the rotor, wherein the first angular position identification layer and the second angular position identification layer are disposed such that a maximum width of the first angular position identification layer and a maximum width of the second angular position identification layer do not overlap each other in a rotation direction of the rotor.

The first angular position identification layer and the second angular position identification layer have substantially a same shape, each of the first angular position identification layer and the second angular position identification layer has a sinusoidal wave-shaped boundary line, and a first of the first angular position identification layer and the second angular position identification layer rotates ¼ turn more than a second of the first angular position identification layer and the second angular position identification layer to be disposed to surround the surface of the rotor.

In a general aspect, an electronic device includes a rotor apparatus, the rotor apparatus includes a rotor, configured to rotate around a rotational axis; an angular position identification layer, configured to surround an inner surface of the rotor, and configured to rotate with the rotor, and configured to have a width that varies based on an angular position of the rotor; and a permeability layer, configured to surround the inner surface of the rotor and configured to have a higher permeability than a permeability of the rotor.

The electronic device may include a body having an upper surface, configured to output display information, and a first surface on which the rotor apparatus is disposed.

The electronic device may further include a strap coupled to a second surface of the body, wherein a flexibility level of the strap is greater than a flexibility level of the body.

In a general aspect, an electronic device includes a rotor apparatus, the rotor apparatus including a rotor, configured to rotate around a rotational axis; and an angular position identification layer, configured to surround an inner surface of the rotor, and configured to rotate with the rotor, and configured to have a width that varies based on an angular position of the rotor, wherein the rotor is configured to have a higher permeability than the angular position identification layer.

The electronic device may include a body comprising an upper surface, configured to output display information, and a first surface on which the rotor apparatus is disposed.

The electronic device may include a strap coupled to a second inner surface of the body and more flexible than the body.

In a general aspect, a rotor apparatus includes a rotor, including an angular position identification layer, configured to surround an inner surface of the rotor; and a permeability layer, configured to surround an inner surface of the rotor; wherein a permeability of the rotor is higher than a permeability of the angular position identification layer, and a permeability of the permeability layer is higher than a permeability of the rotor.

The rotor may be composed of a plastic material.

The permeability layer may be disposed to overlap the angular position identification layer on the inner surface of the rotor.

Other features and aspects will be apparent from the following detailed description, the drawings, and the claims.

### BRIEF DESCRIPTION OF DRAWINGS

FIG. 1 is an exploded view illustrating an example specific shape of a rotor apparatus, in accordance with one or more embodiments.

FIGS. 2A and 2B are perspective views of an example rotor apparatus, in accordance with one or more embodiments.

FIGS. 3A and 3B are perspective views of a permeability layer which may be included in an example rotor apparatus, in accordance with one or more embodiments.

FIGS. 4A and 4B are perspective views of first and second angular position identification layers which may be included in an example rotor apparatus, in accordance with one or more embodiments.

FIGS. 5A and 5B are exploded views of a side surface of a rotor of an example rotor apparatus, in accordance with one or more embodiments.

FIG. 6A is a graph illustrating example relative inductances for reference inductances of first and second inductors depending on an angular position of a rotor of an example rotor apparatus, in accordance with one or more embodiments.

FIG. 6B is a graph illustrating the sum of the relative inductances of FIG. 6A and an arctangent processing value.

FIG. 7A is a graph illustrating inductance corresponding to an angular position of first and second angular position identification layers of the rotor apparatus illustrated in FIGS. 2A and 2B.

FIG. 7B is a graph illustrating inductance corresponding to an angular position of first and second angular position identification layers of the rotor apparatus illustrated in FIGS. 3A and 3B.

FIGS. 8A and 8B are views illustrating an example electronic device which may include a rotor apparatus, in accordance with one or more embodiments.

Throughout the drawings and the detailed description, the same reference numerals refer to the same elements. The drawings may not be to scale, and the relative size, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure. Hereinafter, while embodiments of the present disclosure will be described in detail with reference to the accompanying drawings, it is noted that examples are not limited to the same.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. As used herein “portion” of an element may include the whole element or less than the whole element.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may be also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of this disclosure. Further, although the examples described herein have a variety of configurations, other configurations are possible as will be apparent after an understanding of this disclosure.

Herein, it is noted that use of the term “may” with respect to an example, for example, as to what an example may include or implement, means that at least one example exists in which such a feature is included or implemented while all examples are not limited thereto.

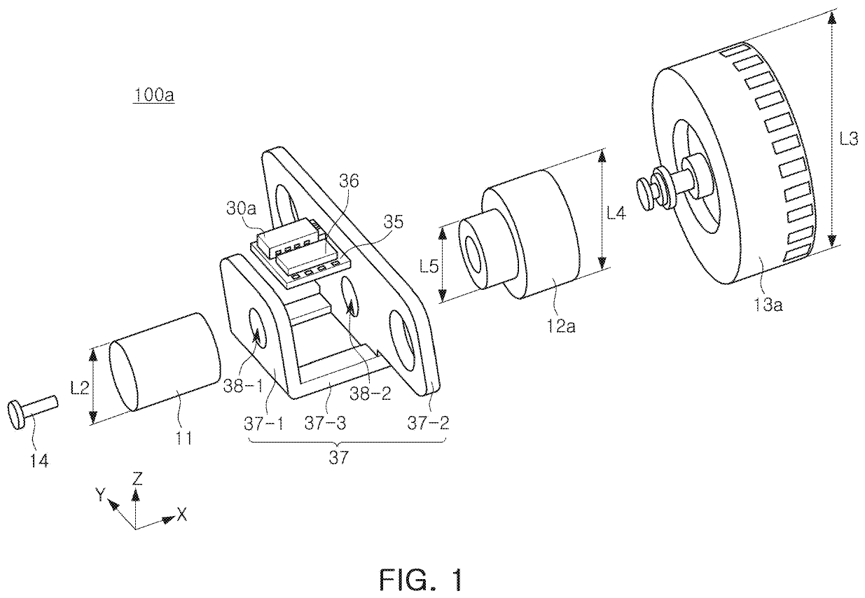

FIG. 1 is an exploded view illustrating a specific shape of an example rotor apparatus, in accordance with one or more embodiments.

Referring to FIG. 1, a rotor apparatus 100a according to an example may include a rotor 11, a rotary connector 12a, a rotary head 13a, a pin 14, an inductor 30a, a substrate 35, an angular position sensing circuit 36, and a base member 37.

A first end of the rotor 11 may be coupled to the rotary head 13a through the rotary connector 12a, and a second end of the rotor 11 may be coupled to the pin 14. A structure, in which the rotor 11, the rotary connector 12a, the rotary head 13a, and the pin 14 are coupled to each other, may rotate together around a rotational axis (for example, an X-axis). In an example, the rotor 11 may have a cylindrical shape or a polygonal columnar (for example, octagonal columnar) shape.

The rotary head 13a may be configured to efficiently apply a torque from an external entity. In an example, the rotary head 13a may have a plurality of grooves to prevent a human hand from sliding while the human hand is in contact with the rotary head 13a. In an example, the rotary head 13a may have a diameter L3 that is larger than a diameter L2 of the rotor 11 such that the human hand effectively applies force to the rotary head 13a. In an example, the rotary head 13a may be a crown of a watch.

In a non-limiting example, at least one of the rotor 11 and the rotary head 13a may include a plastic material. Accordingly, a weight of the rotor apparatus 100a may be reduced such that the rotor 11 and the rotary head 13a may be rotated by the human hand.

The rotary connector 12a may be configured to efficiently rotate, in response to the torque applied to the rotary head 13a. In an example, the rotation connector 12a may have a structure of spindles, and may be coupled to the rotation head 13a according to a screw coupling structure. In an example, the rotation connector 12a may have a cylindrical shape in which a diameter L4 of a first end and a diameter L5 of a second end may be different from each other.

A structure, in which the rotor 11 and the rotary connector 12a and the rotary head 13a and the pin 14 are coupled to each other, may be disposed on the base member 37. The base member 37 may be configured to be fixed to an electronic device.

For example, the base member 37 may have a structure in which a first part 37-1, a second part 37-2, and a third part 37-3 are coupled to each other. The first and second parts 37-1 and 37-2 may have first and second through-holes 38-1 and 38-2, respectively. The third part 37-3 may be connected between the first part 37-1 and the second part 37-2, and may be configured to be perpendicular to the respective first and second parts 37-1 and 37-2.

The rotor 11 may be disposed to penetrate through at least one of the respective first and second through-holes 38-1 and 38-2. Accordingly, the rotor 11 may maintain a separation distance from the inductor 30a while rotating and may stably rotate, and thus, may have a longer lifespan.

The base member 37 may fix a positional relationship between the inductor 30a and the rotor 11. In an example, the inductor 30a may be fixedly disposed on the substrate 35, and the substrate 35 may be fixedly disposed on the base member 37.

The substrate 35 may have a structure, in which at least one wiring layer and at least one insulating layer are alternately stacked, such as a printed circuit board (PCB). The inductor 30a may be electrically connected to the wiring layer.

The angular position sensing circuit 36 may be disposed on the substrate 35 and may be electrically connected to the inductor 30a through the wiring layer of the substrate 35. In an example, the angular position sensing circuit 36 may be implemented as an integrated circuit, and may be mounted on an upper surface of the substrate 35.

The angular position sensing circuit 36 may generate an angular position value based on the inductance of the inductor 30a. In an example, the angular position sensing circuit 36 may output an output signal to the inductor 30a, and may receive an output signal and an input signal based on the inductance of the inductor 30a. Since the resonance frequency of the output signal may depend on the inductance of the inductor 30a, the angular position sensing circuit 36 may detect a resonant frequency of the output signal to ascertain the inductance of the inductor 30a, and may generate an angular position value corresponding to the inductance of the inductor 30a.

The inductor 30a may generate magnetic flux based on the output signal received from the angular position sensing circuit 36. The inductor 30a may be disposed to output magnetic flux toward the rotor 11. In a non-limiting example, the inductor 30a may have a coil shape, and may have a structure in which at least one insulating layer and at least one coil layer, including wound wires, are alternately stacked.

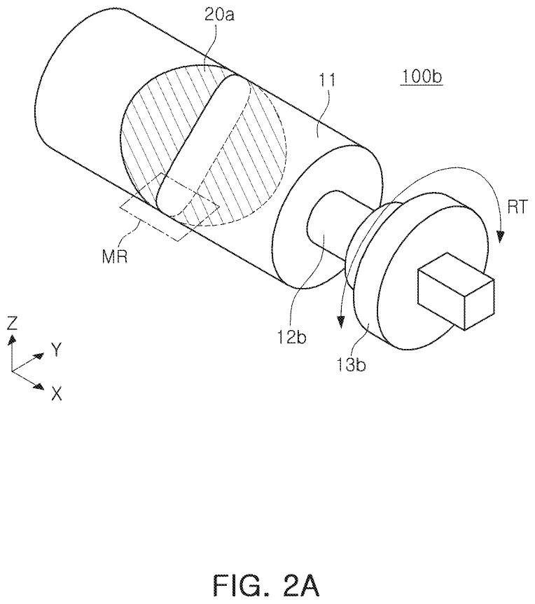

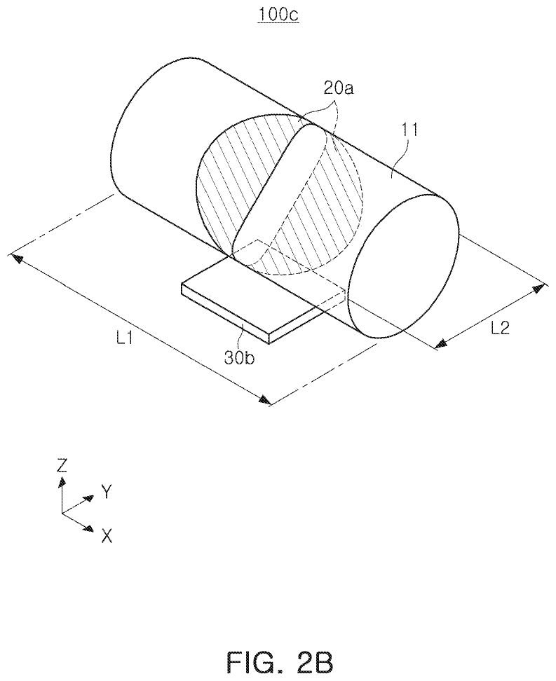

FIGS. 2A and 2B are perspective views of an example rotor apparatus, in accordance with one or more embodiments.

Referring to FIG. 2A, a rotor apparatus 100b according to an example may include a rotor 11 and an angular position identification layer 20a.

The rotor 11 may be configured to rotate in a clockwise direction RT or counterclockwise direction along a rotational axis (for example, an X-axis). Magnetic flux around the rotor 11 may pass through a magnetic flux region MR of a side surface of the rotor 11. An angular position of the magnetic flux region MR may be determined based on a rotation of the rotor 11.

The angular position identification layer 20a may be disposed to surround the side surface, or an inner surface, of the rotor 11 and to rotate according to the rotation of the rotor, and may have a width that varies, depending on the angular position of the rotor 11. In an example, the angular position identification layer 20a may be plated on the side surface of the rotor 11, and may be fitted to the rotor 11 in the state in which it is manufactured in advance in the form of a ring.

The magnetic flux, that passes through the magnetic flux region MR on the side surface of the rotor 11, may generate an eddy current in the angular position identification layer 20a. Since a direction of the eddy current is similar to a current direction of a coil, the eddy current may act as a parasitic inductor and may provide parasitic inductance.

The larger a diameter of a coil, the higher the inductance of the coil. Therefore, the larger a diameter of a region in which eddy current is generated, the higher the inductance depending on an eddy current.

The larger a width of a portion corresponding to the magnetic flux region MR in the angular position identification layer 20a, the larger a diameter of a region in which an eddy current is generated.

Since the width of the angular position identification layer 20a may vary based on the angular position of the rotor 11, the diameter of the region, in which the eddy current is generated on the angular position identification layer 20a, may vary depending on the angular position of the rotor 11. In an example, inductance that is based on the eddy current that is generated by the magnetic flux passing through the magnetic flux region MR, may vary depending on the angular position of the rotor 11.

Therefore, the angular position identification layer 20a may provide inductance based on the degree of rotation of the rotor 11.

The greater a change in inductance of the eddy current, that is based on a change in the width of the angular position identification layer 20a, the higher the precision and accuracy of the angular position identification of the rotor 11.

The rotor 11 may have a higher permeability than the angular position identification layer 20a. Accordingly, the precision and accuracy of angular position identification of the rotor 11 may be improved.

In an example, the rotor 11 may be implemented using a magnetic material such as ferrite, steel, iron, and nickel.

In an example, the angular position identification layer 20a may include at least one of copper, silver, gold, and aluminum. Accordingly, since the angular position identification layer 20a may have high conductivity, a higher eddy current may be generated. In general, a high-conductivity metal may have low permeability. Since the rotor 11 has relatively high permeability, the rotor apparatus 100b according to an example may further improve the precision and accuracy of the angular position identification using an eddy current generated based on high conductivity and inductance formed based on high permeability.

In an example, a first end of the rotor 11 may be coupled to a rotary head 13b through a rotary connector 12b. The rotary head 13b may be composed of, as a non-limiting example, a plastic material. Accordingly, the rotor apparatus 100b according to an example may have a relatively low weight while using the rotor 11 implemented as a relatively heavy magnet, and thus, may relatively easily receive external torque.

Referring to FIG. 2B, a rotor apparatus 100c according to an example may have a structure in which a rotary connector and a rotary head are omitted.

An inductor 30b may be disposed to overlap angular position identification layer 20a in a normal direction of a side surface of a rotor 11.

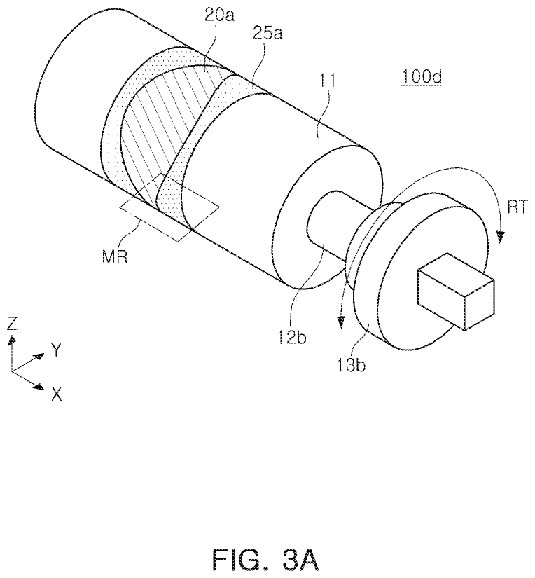

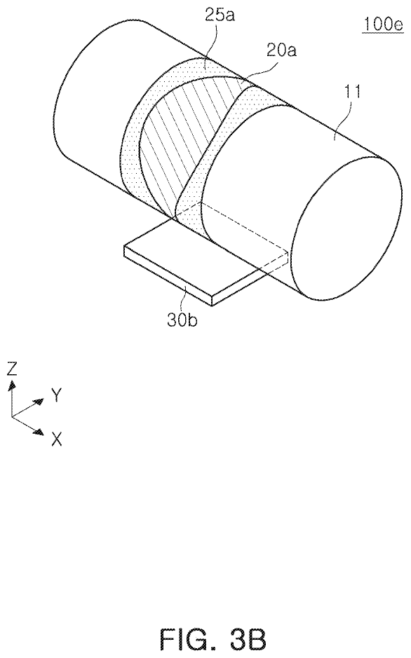

FIGS. 3A and 3B are perspective views of a permeability layer which may be included in an example rotor apparatus, in accordance with one or more embodiments.

Referring to FIG. 3A, a rotor apparatus 100d according to an example may include a rotor 11, an angular position identification layer 20a, and a permeability layer 25a.

The permeability layer 25a may be disposed to surround a side surface of the rotor 11 and may have higher permeability than the rotor 11. Accordingly, precision and accuracy of the angular position identification of the rotor 11 may be improved.

Additionally, since the permeability layer 25a may provide relatively high permeability, a material of the rotor 11 may be more freely set. In an example, the rotor 11 may not have higher permeability than the angular position identification layer 20a, and may be composed of a plastic material to have a relatively light weight, and may be implemented as a lower cost material than a magnetic material.

In an example, the permeability layer 25a may be implemented as a magnetic material such as ferrite, steel, iron, and nickel and may be plated on a side surface of the rotor 11 (for example, nickel plating), and may be fitted into the rotor 11 in the state in which it is manufactured in advance in the form of a ring (for example, manufactured according to a steel process).

In an example, the permeability layer 25a may be disposed to overlap the angular position identification layer 20a in a normal direction of the side surface of the rotor 11. Accordingly, since a change in inductance of an eddy current, that is based on a change in a width of the angular position identification layer 20a, may be further increased, precision and accuracy of the angular position identification of the rotor 11 may be further improved.

Referring to FIG. 3B, a rotor apparatus 100e according to an example may have a structure in which a rotary connector and a rotary head are omitted.

An inductor 30b may be disposed to overlap a permeability layer 25a in a normal direction of a side surface of a rotor 11.

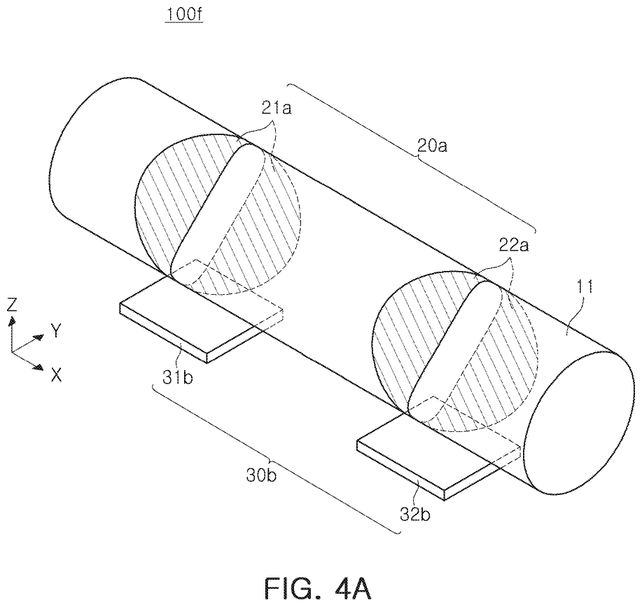

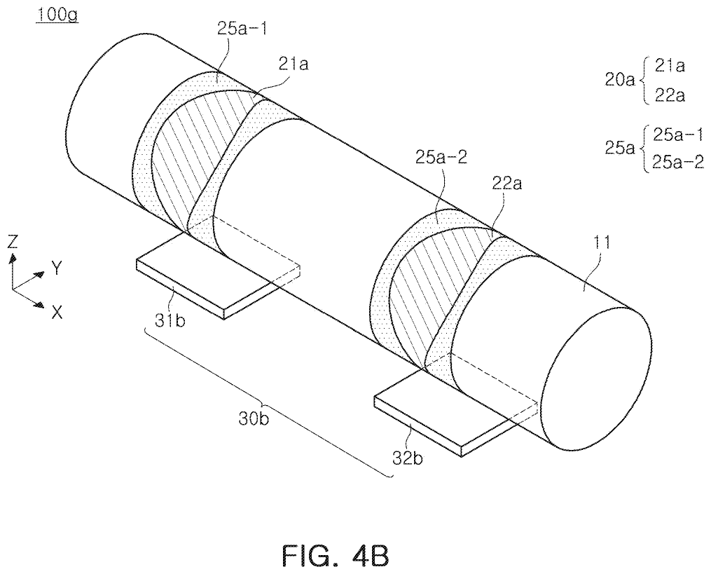

FIGS. 4A and 4B are perspective views of first and second angular position identification layers which may be included in a rotor apparatus, in accordance with one or more embodiments.

Referring to FIG. 4A, an angular position identification layer 20a of a rotor apparatus 100f according to an example may include a first angular position identification layer 21a and a second angular position identification layer 22a. Additionally, the inductor 30b may include a first inductor 31b and a second inductor 32b.

The first angular position identification layer 21a may be disposed to surround a side surface of the rotor 11, and may have a width that varies based on an angular position of the rotor 11.

The second angular position identification layer 22a may be spaced apart from the first angular position identification layer 21a to surround the side surface, for example, an inner side surface, of the rotor 11, and may have a width that varies based on the angular position of the rotor 11.

Changes in first and second inductances of the first and second inductor 31b and 32b based on first and second eddy current of the first and second angular position identification layers 21a and 22b according to rotation of the rotor 11, may be used together to identify an angular position of the rotor 11.

Accordingly, since a difference between a maximum width and a minimum width of each of the first and second angular position identification layers 21a and 22a may be prevented from significantly increasing, linearity of a change in inductance that is based on a change in width of each of the first and second angular position identification layers 21a and 22a may be further improved.

Referring to FIG. 4B, a permeability layer 25a of a rotor apparatus 100g, according to an example, may include a first permeability layer 25a-1 and a second permeability layer 25a-2.

The first permeability layer 25a-1 may be disposed to surround a side surface of a rotor 11 and may have higher permeability than the rotor 11, and may have a larger width than a maximum width of the first angular position identification layer 21a.

The second permeability layer 25a-2 may be spaced apart from the first permeability layer 25a-1 to surround the side surface, for example, the inner side surface, of the rotor 11, and may have higher permeability than the rotor 11 and may have a larger width than a maximum width of the second angular position identification layer 22a.

Accordingly, since electromagnetic independence between the first and second angular position identification layers 21a and 22a may be further increased, precision and accuracy of angular position identification of the rotor 11 may be further improved.

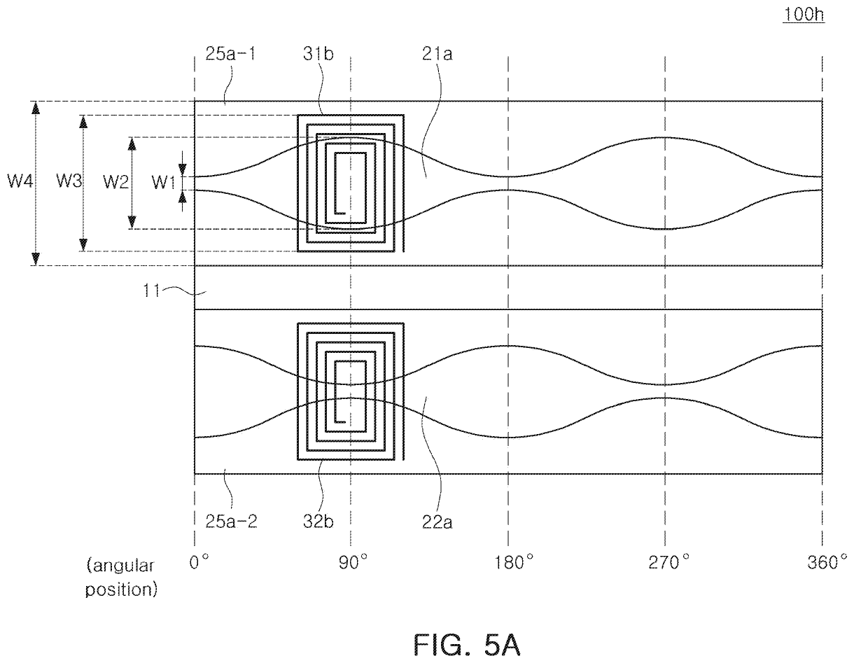

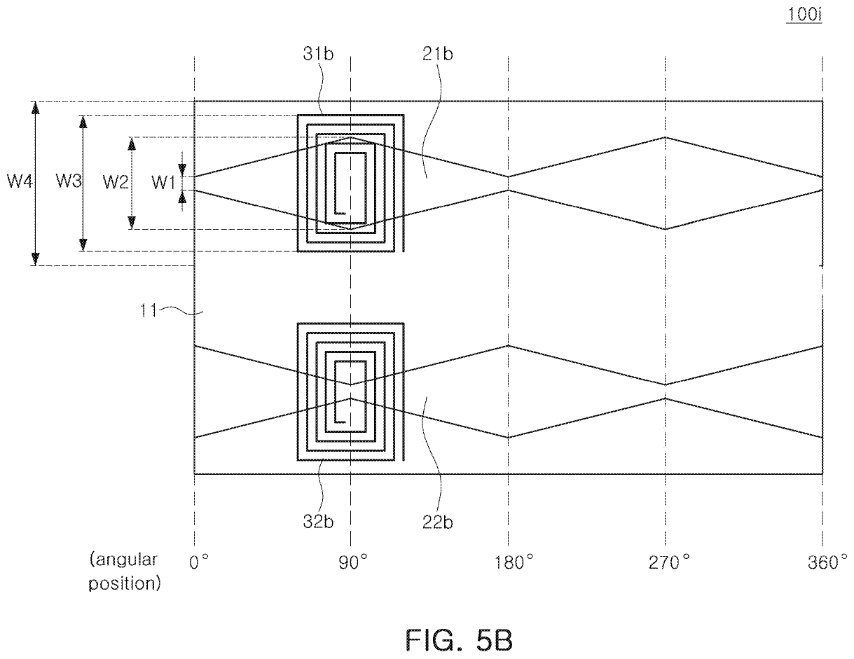

FIGS. 5A and 5B are exploded views of a side surface of a rotor of an example rotor apparatus, in accordance with one or more embodiments.

Referring to FIG. 5A, a first angular position identification layer 21a and a second angular position identification layers 22a of a rotor apparatus 100h, according to an example, may be disposed such that a maximum width W2 of the first angular position identification layer 21a and a maximum width of the second angular position identification layer 22a do not overlap with each other in a rotation direction of a rotor 11.

Accordingly, an electromagnetic effect of eddy current of one of the first and second angular position identification layers 21a and 22a on the other can be reduced. Thus, precision and accuracy of an angular position identification of the rotor 11 may be further improved.

In an example, the first and second angular position identification layers 21a and 22a may have the same shape and may have a maximum width W2 and a minimum width W1, respectively.

A width W4 of each of the first and second permeability layers 25a-1 and 25a-2 may be larger than the maximum width W2 of each of the first and second angular position identification layers 21a and 22a.

Accordingly, the first and second inductances may change based on changes in widths of the first and second angular position identification layers 21a and 22a, and the change in inductance may be more linear in relatively wide portions of the first and second angular position identification layers 21a and 22a. Thus, precision and accuracy of angular position identification of the rotor 11 may be further improved.

A width W3 of each of the first and second inductors 31b and 32b may be smaller than a width W4 of each of the first and second permeability layers 25a-1 and 25a-2.

In an example, one of the first and second angular position identification layers 21a and 22a may rotate a ¼ turn (90 degrees) more than the other thereof to be disposed to surround the side surface of the rotor 11. Each of the first and second angular position identification layers 21a and 22a may have a sinusoidal wave-shaped boundary line.

Accordingly, a value obtained by arctangent (arctan) processing performed on first and second inductances of the first and second inductors 31b and 32b may be changed at a constant change rate depending on a change in the angular position of the rotor 11.

Referring to FIG. 5B, first and second angular position identification layers 21b and 22b of a rotor apparatus 100i, according to an example, may each have a linear boundary.

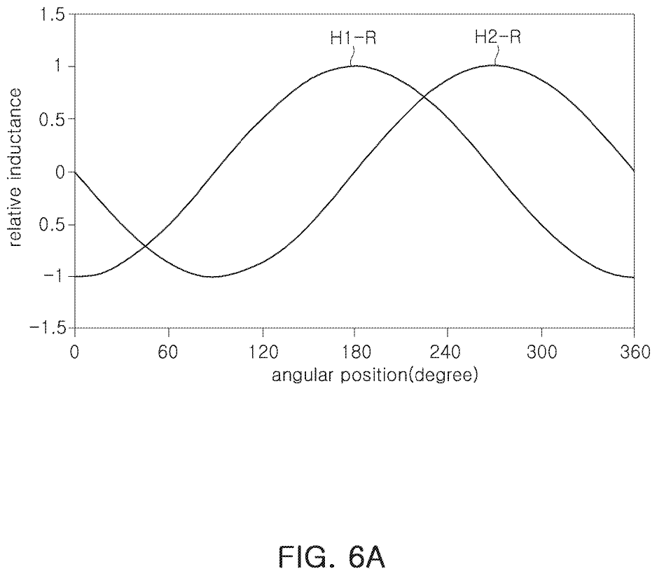

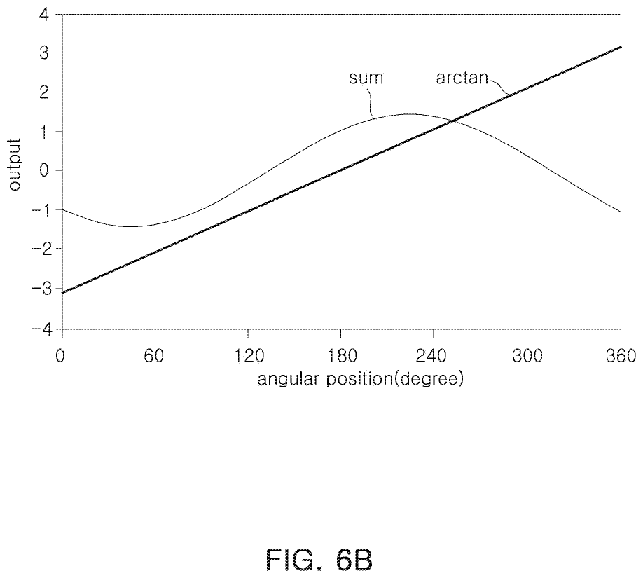

FIG. 6A is a graph illustrating relative inductances for reference inductances of first and second inductors based on an angular position of a rotor of a rotor apparatus, in accordance with one or more embodiments.

Referring to FIG. 6A, first relative inductance H1-R of a first inductor and second relative inductance H2-R of a second inductor may form a phase difference of 90 degrees from each other.

FIG. 6B is a graph illustrating the sum of the relative inductances of FIG. 6A and an arctangent processing value.

Referring to FIG. 6B, the sum of the first and second relative inductances of FIG. 6A may form a sinusoidal wave shape, and an arctan processing value of the first and second relative inductances of FIG. 6A may be changed at a constant change rate based on a change in an angular position of a rotor.

When the first and second relative inductances form a phase difference of 90 degrees from each other, one of the first and second relative inductances may correspond to {sin(an angular position)} and the other may correspond to {cos(an angular position)}.

In a trigonometric function model, an angle from an origin of a circle toward a certain point of the circle may correspond to an angular position of the rotor, a distance from the origin to the certain point of the circle may be r, and an x-direction vector value and a y-direction vector value form the origin to the certain point of the circle may be x and y, respectively.

{sin(an angular position)} is y/r, and {cos(an angular position)} is x/r. {tan(an angular position)} is y/x, {(sin (angular position)}/{cos (angular position)}, and is (second relative inductance)/(first relative inductance).

Therefore, arctan{(second relative inductance)/(first relative inductance)} may correspond to angular position, and may be an arctan processing value.

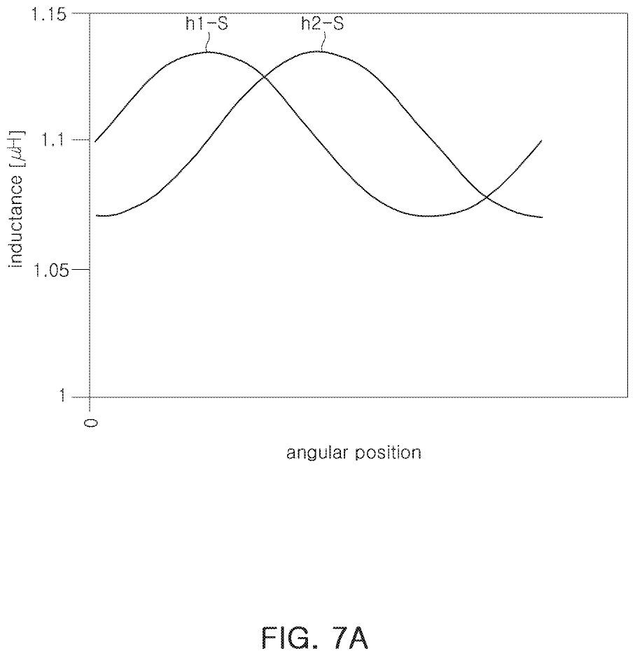

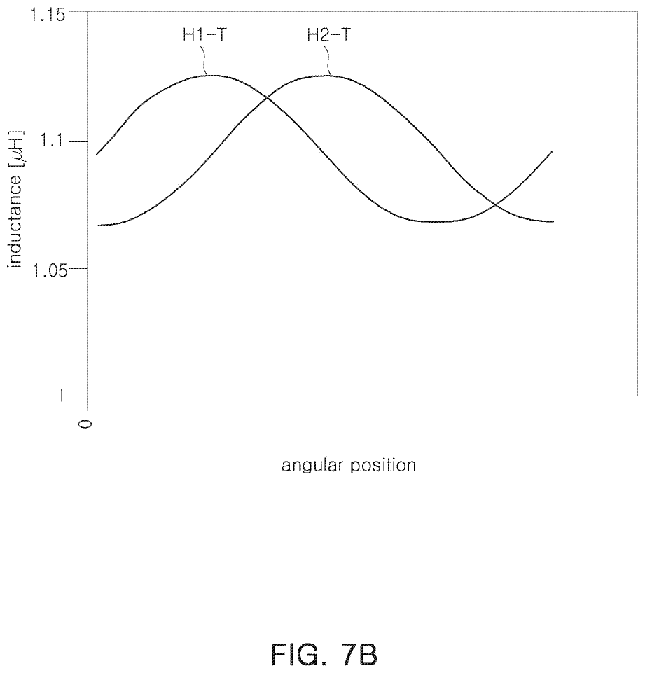

FIG. 7A is a graph illustrating inductance corresponding to an angular position of first and second angular position identification layers of the example rotor apparatus illustrated in FIGS. 2A and 2B.

Referring to FIG. 7A, first inductance h1-S of a first inductor and second inductance h2-S of a second inductor may each have a maximum value of 1.1348 μH, a minimum value of 1.0702 μH, and an average value of 1.1012 μH, and a difference between the maximum and minimum values may be 0.0646 μH.

When permeability of the rotor is 1, each of the first inductance of the first inductor and the second inductance of the second inductor may have a maximum value of 1.0900 μH, a minimum value of 1.0564 μH, an average value of 1.0741 μH, and a difference between the maximum value and the minimum value may be 0.0335 μH.

Therefore, the rotor apparatus, according to an example, may increase a change rate of inductance based on a change in the angular position of the rotor by about 93%.

FIG. 7B is a graph illustrating inductance corresponding to an angular position of first and second angular position identification layers of the example rotor apparatus illustrated in FIGS. 3A and 3B.

Referring to FIG. 7B, first inductance H1-T of a first inductor and second inductance H2-T of a second inductor may each have a maximum value of 1.1256 μH, a minimum value of 1.0670 μH, an average value of 1.0948 μH, and a difference between the maximum and minimum values may be 0.0585 μH.

When a permeability layer is omitted in the rotor, each of the first inductance of the first inductor and the second inductance of the second inductor may have a maximum value of 1.0900 μH, a minimum value of 1.0564 μH, an average value of 1.0741 μH, and a difference between the maximum value and the minimum value may be 0.0335 μH.

Accordingly, the rotor apparatus, according to an example, may increase a change rate of inductance depending on a change in an angular position of the rotor by about 75%.

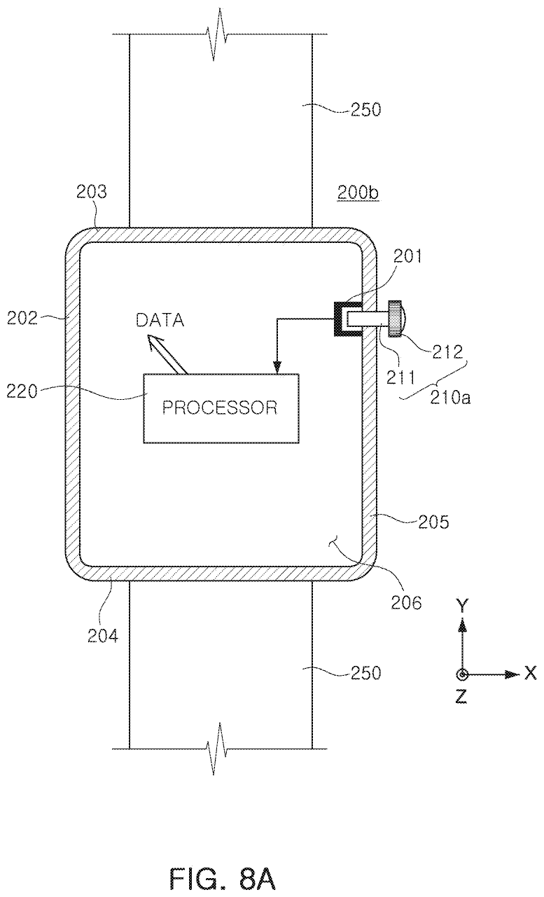

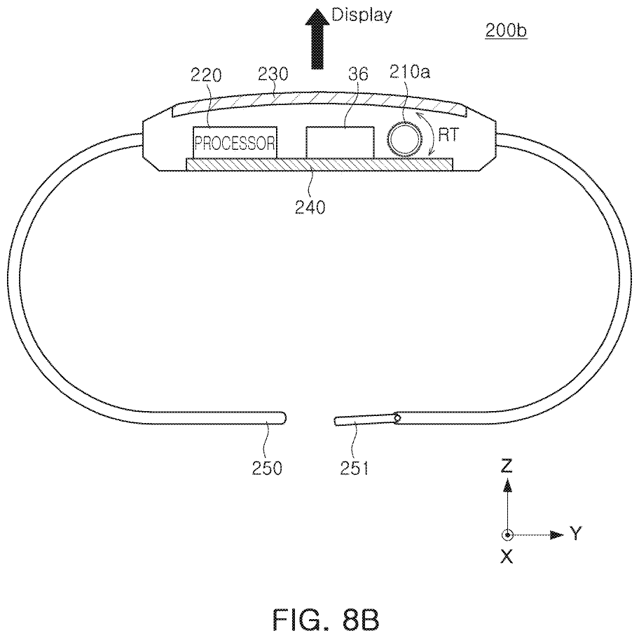

FIGS. 8A and 8B are views illustrating an example electronic device which may include a rotor apparatus, in accordance with one or more embodiments.

Referring to FIG. 8A, an electronic device 200b may include a body having at least two surfaces, among a first surface 205, a second surface 202, a third surface 203, and a fourth surface 204.

In an example, the electronic device 200b may be, as non-limiting examples, a smartwatch, a smartphone, a personal digital assistant (PDA), a digital video camera, a digital still camera, a network system, a computer, a monitor, a tablet personal computer, a laptop computer, a netbook, a television, a video game console, an automotive, or the like, but is not limited thereto.

The electronic device 200b may include a processor 220, and may further include a storage element which stores data, such as a memory or a storage. The electronic device 200b may include a communications element, which remotely transmits and receives data, such as a communications modem or an antenna.

The processor 220 may be disposed in an internal space 206 of the body. The processor 220 is a hardware device, or a combination of hardware and instructions which configure the processor 220 based on execution of the instructions by the processor 220. The processor 220 may be further configured to execute other instructions, applications, or programs, or may be configured to control other operations of the electronic device 200b. The processor 220 may include, for example, a central processing unit (CPU), a graphics processing unit (GPU), a microprocessor, an application specific integrated circuit (ASIC), field programmable gate arrays (FPGA), and/or other processors configured to implement the processes discusses herein, and may have multiple cores. For example, the processor 220 may input and output data to the storage element or the communications element.

A rotor apparatus 210a, according to an example, may include a rotor 211 and a rotary head 212, and may be disposed on a first surface 205 of the body. However, this is only an example, and the rotor apparatus 210a may be disposed on any one of second surface 202, third surface 203, and fourth surface 204.

A housing 201 may surround at least a portion of the rotor apparatus 210a. In a non-limiting example, the housing 201 may be coupled to the first surface 205 of the body. In an example, the housing 201 and the body may be implemented as an insulating material such as, for example, plastic.

A generated angular position value may be transmitted to the processor 220. In an example, the processor 220 may generate data based on the received angular position value, and may transmit the generated data to the storage element or the communications element. The processor 220 may control a display member, outputting display information in a Z direction, based on the generated data.

Referring to FIGS. 8A and 8B, the electronic device 200b may further include a strap 250 connected to at least one of the respective first, second, third, and fourth surfaces 205, 202, 203, and 204 of the body, and may be more flexible than the body.

Accordingly, the strap 250 may be worn over a body (or wear) of a user of the electronic device 200b, so that the user may more conveniently use the electronic device 200b. In an example, a first end and a second end of the strap 250 may be coupled to each other through a coupling portion 251 (FIG. 8B).

Referring to FIG. 8B, the electronic device 200b may include a display member 230 and an electronic device substrate 240, and may further include an angular position sensing circuit 36.

The display member 230 may output display information in a normal direction (for example, a Z direction), different from a normal direction (for example, an X direction and/or a Y direction) of the respective first, second, third and fourth surfaces 205, 202, 203, and 204 of the body. In an example, the normal direction of the display member 230 and the normal direction of a display surface of the body of the electronic device 200b may be the same.

At least a portion of display information that is output by the display member 230, may be based on data generated by the processor 220. In an example, the processor 220 may transmit the display information, based on the generated data, to the display member 230.

In an example, the display member 230 may have a structure in which a plurality of display cells are two-dimensionally disposed and may receive a plurality of control signals, based on operating data of an electronic device, from the processor 220 or an additional processor. The plurality of display cells may be configured to determine whether to display and/or a color based on the plurality of control signals. In an example, the display member 230 may further include a touchscreen panel, and may be implemented as a relatively flexible material such as, but not limited to, an organic light-emitting diode (OLED).

The electronic device substrate 240 may provide a placement space of the processor 220, and may provide a data transmission path between the processor 220 and the display member 230. For example, the electronic device substrate 240 may be implemented as a printed circuit board (PCB).

The angular position sensing circuit 36 may be implemented, similarly to the angular position sensing circuit illustrated in FIG. 1, and may be separated from the rotor apparatus 210a to be disposed on the electronic device substrate 240, unlike the angular position sensing circuit illustrated in FIG. 1.

As described above, according to an example, precision and/or accuracy of angular position identification of a rotor may be improved.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A rotor apparatus comprising:
a rotor, configured to rotate around a rotational axis;
an angular position identification layer, configured to surround a surface of the rotor, and configured to rotate with the rotor, and configured to have a width that varies based on an angular position of the rotor; and
a permeability layer, configured to surround the surface of the rotor, and configured to have a higher permeability than a permeability of the rotor.

2. The rotor apparatus of claim 1, wherein the angular position identification layer comprises:
a first angular position identification layer, disposed to surround the surface of the rotor, and configured to have a width that varies based on the angular position of the rotor; and
a second angular position identification layer, spaced apart from the first angular position identification layer, disposed to surround the surface of the rotor, and configured to have a width that varies based on the angular position of the rotor.

3. The rotor apparatus of claim 2, wherein the first angular position identification layer and the second angular position identification layer are disposed such that a maximum width of the first angular position identification layer and a maximum width of the second angular position identification layer do not overlap each other in a rotation direction of the rotor.

4. The rotor apparatus of claim 3, wherein the first angular position identification layer and the second angular position identification layer have substantially a same shape, and
a first of the first angular position identification layer and the second angular position identification layer rotates ¼ turn more than a second of the first angular position identification layer and the second angular position identification layer to be disposed to surround the surface of the rotor.

5. The rotor apparatus of claim 4, wherein each of the first angular position identification layer and the second angular position identification layer is configured to have a sinusoidal wave-shaped boundary line.

6. The rotor apparatus of claim 2, wherein the permeability layer comprises:
a first permeability layer, disposed to surround the surface of the rotor, and configured to have a higher permeability than the permeability of the rotor, and configured to have a width that is larger than a maximum width of the first angular position identification layer; and
a second permeability layer, spaced apart from the first permeability layer to surround the surface of the rotor, and configured to have a higher permeability than the permeability of the rotor and configured to have a width that is larger than a maximum width of the second angular position identification layer.

7. The rotor apparatus of claim 1, wherein a width of the permeability layer is less than a length of the rotor in a direction of the rotational axis.

8. The rotor apparatus of claim 1, wherein the permeability layer is disposed to overlap the angular position identification layer in a normal direction of the surface of the rotor.

9. The rotor apparatus of claim 1, wherein the angular position identification layer comprises at least one of copper, silver, gold, and aluminum.

10. The rotor apparatus of claim 1, wherein the rotor is composed of a plastic material.

11. The rotor apparatus of claim 10, further comprising:
a rotary head, coupled to a first end of the rotor and configured to have a diameter that is larger than a diameter of the rotor.

12. The rotor apparatus of claim 1, further comprising:
an inductor, configured to output magnetic flux toward the surface of the rotor; and
a base member, configured to fix a positional relationship between the inductor and the rotor.

13. The rotor apparatus of claim 12, further comprising:
an angular position sensing circuit, configured to generate an angular position value based on an inductance of the inductor; and
a substrate, disposed on the base member,
wherein the angular position sensing circuit and the inductor are disposed on the substrate.

14. The rotor apparatus of claim 12, wherein the base member has a through-hole, and
the rotor is configured to penetrate through the through-hole.

15. A rotor apparatus comprising:
a rotor, configured to rotate around a rotational axis; and
an angular position identification layer, configured to surround an inner surface of the rotor, and configured to rotate with the rotor, and configured to have a width that varies based on an angular position of the rotor,
wherein the rotor is configured to have a higher permeability than the angular position identification layer.

16. The rotor apparatus of claim 15, wherein the angular position identification layer comprises at least one of copper, silver, gold, and aluminum.

17. The rotor apparatus of claim 15, further comprising:
a rotary head, coupled to a first end of the rotor, and configured to have a diameter that is larger than a diameter of the rotor,
wherein the rotary head is composed of a plastic material.

18. The rotor apparatus of claim 15, further comprising:
an inductor, configured to output magnetic flux toward the inner surface of the rotor; and
a base member, configured to fix a positional relationship between the inductor and the rotor, and configured to have a through-hole,
wherein the rotor is configured to penetrate through the through-hole.

19. The rotor apparatus of claim 15, wherein the angular position identification layer comprises:
a first angular position identification layer, disposed to surround the inner surface of the rotor, and configured to have a width that varies based on the angular position of the rotor; and
a second angular position identification layer, spaced apart from the first angular position identification layer, disposed to surround the inner surface of the rotor, and configured to have a width that varies based on the angular position of the rotor,
wherein the first angular position identification layer and the second angular position identification layer are disposed such that a maximum width of the first angular position identification layer and a maximum width of the second angular position identification layer do not overlap each other in a rotation direction of the rotor.

20. The rotor apparatus of claim 19, wherein the first angular position identification layer and the second angular position identification layer have substantially a same shape,
each of the first angular position identification layer and the second angular position identification layer has a sinusoidal wave-shaped boundary line, and
a first of the first angular position identification layer and the second angular position identification layer rotates ¼ turn more than a second of the first angular position identification layer and the second angular position identification layer to be disposed to surround the inner surface of the rotor.

21. An electronic device comprising a rotor apparatus, the rotor apparatus comprising:
a rotor, configured to rotate around a rotational axis;
an angular position identification layer, configured to surround an inner surface of the rotor, and configured to rotate with the rotor, and configured to have a width that varies based on an angular position of the rotor; and
a permeability layer, configured to surround the inner surface of the rotor and configured to have a higher permeability than a permeability of the rotor.

22. The electronic device of claim 21, further comprising:
a body having an upper surface, configured to output display information, and a first surface on which the rotor apparatus is disposed.

23. The electronic device of claim 22, further comprising:
a strap coupled to a second surface of the body,
wherein a flexibility level of the strap is greater than a flexibility level of the body.

24. An electronic device comprising a rotor apparatus, the rotor apparatus comprising:
a rotor, configured to rotate around a rotational axis; and
an angular position identification layer, configured to surround an inner surface of the rotor, and configured to rotate with the rotor, and configured to have a width that varies based on an angular position of the rotor,
wherein the rotor is configured to have a higher permeability than the angular position identification layer.

25. The electronic device of claim 24, further comprising:
a body comprising an upper surface, configured to output display information, and a first surface on which the rotor apparatus is disposed.

26. The electronic device of claim 25, further comprising:
a strap coupled to a second surface of the body and more flexible than the body.
